(19) United States
(12) Patent Application Publication
(10) Pub. No.: US 2007/0028700 A1
(43) Pub. Date: Feb. 8, 2007

(54) Acoustic wave torque sensor

(76) Inventors: James ZT. Liu, Belvidere, IL (US); Scott L. Bunyer, Freeport, IL (US); Steven J. Magee, Lena, IL (US); Fred W. Hintz, Freeport, IL (US); Randy J. Hasken, Lanark, IL (US); Richard M. Andrews, Freeport, IL (US)

Correspondence Address: Kris T. Fredrick;Honeywell International, Inc, 101 Columbia Rd., P.O. Box 2245, Morristown, NJ, 07962, US

(21) Appl. No.: 11/199,741

(22) Filed: Aug. 8, 2005

(51) Int. Cl. G01N 29/04

(52) U.S. Cl. 73/801

(57) ABSTRACT

A device, system, and method for measuring torque, comprising an acoustic wave device removably attached to a rotatable shaft by a variably-shaped retainer, wherein removal of the acoustic wave device with the variably-shaped retainer facilitates servicing and replacement of the torque measurement device. The acoustic wave device can be removably attached to the rotatable shaft by using one or more connectors. Other acoustic wave devices such as acoustic wave resonators, surface acoustic wave delay lines, surface acoustic wave filters, and surface transverse waves can also be removably attached to the rotatable shaft to measure torque.

### TECHNICAL FIELD

Embodiments are generally related to sensor devices, systems and methods and, in particular, to acoustic wave sensor devices, systems and methods. Embodiments are additionally related to passive acoustic wave sensor devices, such as, for example, surface acoustic wave (SAW) devices and sensors that measure mechanical qualities of various structures. Embodiments are additionally related to wireless sensing devices utilized in torque detection.

### BACKGROUND

Passive sensors employing acoustic wave components for measuring torque are well known in the art. Torque measurement devices are an emerging technology with varied applications in automotive, transportation, rail and other similar segments for use in transmission and chassis applications, to name a few. Acoustic wave sensors are so named because they use a mechanical or acoustic wave as the sensing mechanism. As the acoustic wave propagates through or on the surface of the material, any changes to the characteristics of the propagation path affect the velocity, phase, and/or amplitude of the wave.

Working at very high frequencies, these extremely high-quality value (high Q value) sensing devices can be wirelessly excited with an interrogation pulse and a resonant frequency response measured allowing strain to be calculated. Torque can be sensed by using appropriate packaging and algorithms to deduce the value of the sensed property from the returned signal. These devices are cost-effective to manufacture, remarkably stable, and offer significantly higher performance than their 20^{th} century, resistance gauge counterparts.

Unlike a conventional wire strain gauge, an acoustic wave torque sensor can store energy mechanically. Once supplied with a specified amount of energy (e.g., via radio frequency), these devices can function without cumbersome oscillators or auxiliary power sources. This capability has been exploited in many wireless/passive sensing operations, such as tire pressure sensors, and optimization of power-train efficiency.

When an acoustic wave device is used in sensor applications, the effect of an electric pulse applied to the inter-digital transducers (IDTs) is to cause the device to act as a transducer. The electric signal is converted to an acoustic wave which is transmitted via the piezoelectric substrate to the other IDTs. Upon arrival of the acoustic wave at the IDTs, the transducing process is reversed and an electric signal is generated. This output signal has a characteristic resonant frequency, or delay time which is dependent upon a number of factors including the geometry of the IDT spacing. Since the IDT spacing varies with strain/stress when the substrate is deformed, any change in this condition can be monitored by measuring the acoustic wave device frequency or delay time.

A known method of measuring torque in a shaft or other torque transmitting component through use of an acoustic wave device is described in can be mounted using an adhesive on the base and the acoustic wave torque sensors are then permanently welded onto the shaft. FIG. 1 illustrates a side view of an example of prior art, wherein the acoustic wave torque device 2 is permanently welded onto a rotatable shaft 4. Note that in this prior art configuration as depicted in FIG. 1, the acoustic wave torque device 2 can only be removed by breaking the weld connecting the acoustic wave torque device 2 to the rotatable shaft 4, thus resulting in damage to the acoustic wave torque device 2. This new design seeks to attach the torque device in a manner in which the device can be removed for maintenance and replacement.

In summary, the device and accompanying methods disclosed herein can extend the functional life of these acoustic wave torque sensors, resulting in a reduction in overall cost to consumer, while promoting an increase in sensing efficiency.

### BRIEF SUMMARY

The following summary is provided to facilitate an understanding of some of the innovative features unique to the embodiments and is not intended to be a full description. A full appreciation of the (various aspects of the embodiments can be gained by taking the entire specification, claims, drawings, and abstract as a whole.

It is, therefore, one aspect of the embodiments to provide for improved torque sensing devices, systems, and methods.

It is another aspect of the embodiments to provide for a torque measurement device and/or system, which can be removably attached to facilitate serviceability and replacement.

It is a further aspect of the embodiments to provide for a torque measurement system, which can be removably attached using a variably-shaped retainer, and one or more associated connectors.

The aforementioned aspects and other objectives and advantages can now be achieved as described herein. A torque measurement system is disclosed, which includes an acoustic wave sensor that is removably attached to a shaft, wherein a removal of the acoustic wave device with the variably-shaped retainer facilitates servicing and replacement of the torque measurement device. Other acoustic wave devices such as acoustic wave resonators, surface acoustic wave delay lines, surface transverse waves, and surface acoustic wave filters can also be removably attached to the rotatable shaft, depending upon design considerations and the specific goals of the torque detection system.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a side view of a prior art configuration, wherein the acoustic wave torque device is permanently welded onto a rotatable shaft;

FIG. 2(a) illustrates a side view of the acoustic wave torque device, removably attached by at least one connector and a variably-shaped retainer to a rotatable shaft that can be adapted for use in accordance with a preferred embodiment;

FIG. 2(b) illustrates an exploded view of the acoustic wave torque device depicted in FIG. 2(a) in accordance with a preferred embodiment;

FIG. 3 illustrates a side view of the acoustic wave torque device, removably attached to a rotatable shaft by an adhesive that can be implemented in accordance with one embodiment;

FIG. 4 illustrates a side view of multiple acoustic wave torque devices, removably attached to a rotatable shaft that is dynamically actuated by a motor that can be implemented in accordance with a preferred embodiment.

FIG. 5 illustrates a passive acoustic wave sensor system having a SAW resonator torque sensing device that can be adapted for use in accordance with a preferred embodiment; and

FIG. 6 illustrates the principle of operating the passive acoustic wave torque sensor system of FIG. 1 using an interrogation unit.

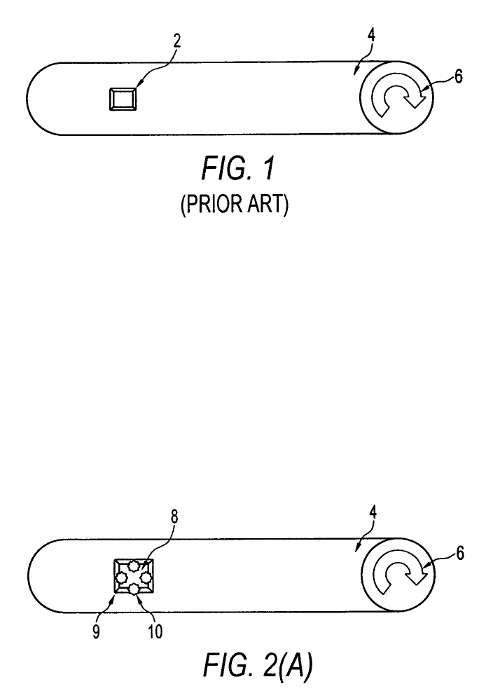

### DETAILED DESCRIPTION OF THE INVENTION

The particular values and configurations discussed in these non-limiting examples can be varied and are cited merely to illustrate at least one embodiment and are not intended to limit the scope thereof.

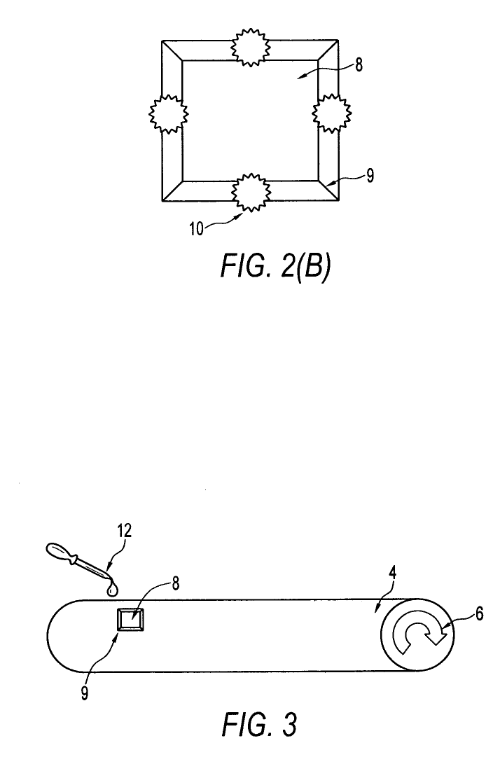

FIG. 2(a) illustrates a side view of an acoustic wave torque device 8, removably attached by at least one connector 10 and a variably-shaped retainer 9 to a shaft 4 that can be adapted for use in accordance with a preferred embodiment. The shaft 4 depicted in FIG. 2(a) is under a clockwise rotation 6 for purposes of illustration only. Note that the acoustic wave torque device 8 depicted in FIG. 2(a) is described herein for illustrative purposes only and is not considered a limiting feature of the embodiments. Instead, acoustic wave torque device 8 is provided in order to depict the context in which one embodiment can be implemented. The embodiment of FIG. 2(a) is therefore provided for exemplary and edification purposes only and may be modified or varied, depending upon design considerations. Note that in FIGS. 2(a), 2(b), 3, and 4 identical or similar parts or elements are generally indicated by identical reference numerals.

FIG. 2(b) illustrates an exploded view of the acoustic wave torque device 8 depicted in FIG. 2(a) in accordance with a preferred embodiment. Note that the illustration of the acoustic wave torque device 8 depicted in FIG. 2(a) comprises a plurality of connectors 10, each connector 10 located at the midpoint of the equal sides of a square-shaped retainer 9. Again, the embodiment of FIG. 2(b) is provided for illustrative purposes only and may be modified or varied, depending upon design considerations. Such considerations might comprise various geometric shapes for the retainer 9, thus resulting in a change in the location of at least one of the aforementioned connectors 10, based upon the desired application for the invention.

FIG. 3 illustrates a side view of the acoustic wave torque device 8, removably attached by a variably-shaped retainer 9 and an adhesive 12 that can be implemented in accordance with one embodiment. The adhesive 12 comprises a form which is removable to facilitate serviceability and replacement of the acoustic wave torque device 8. The shaft 4 depicted in FIG. 3 is under a clockwise rotation 6 for purposes of illustration only.

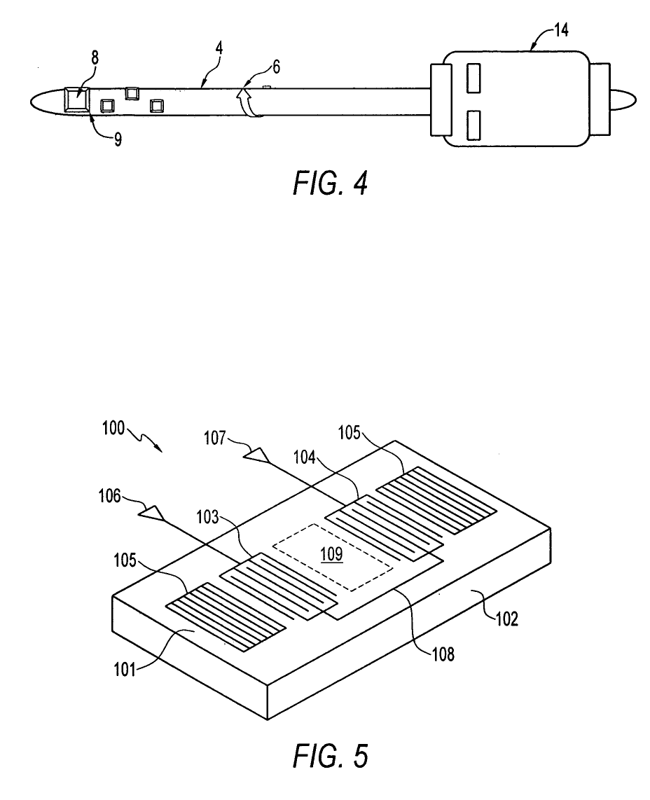

FIG. 4 illustrates a side view of multiple acoustic wave torque devices 8, removably attached to a shaft 4 that is dynamically actuated by a motor 14 in a clockwise direction 6 that can be implemented in accordance with a preferred embodiment. The placement of the acoustic wave torque devices 8 as depicted in FIG. 4 is illustrative only and may be modified or varied, depending upon design considerations. One non-limiting example of a torque measurement application in which one or more of the methods and systems disclosed herein can be implemented is disclosed in WO91/13832, “Method and Apparatus for Measuring Strain,” and issued to Lonsdale, et al. on Oct. 15, 1992. In WO91/13832, multiple acoustic wave torque devices were attached to a rotatable shaft in complementary pairs, so that one acoustic wave torque device is under compression and the other acoustic wave torque device is under tension. The output resonant frequency signal of the multiple acoustic wave torque devices were processed to derive the dynamic torque produced by the rotatable shaft.

Referring to FIG. 5 of the accompanying drawings, which illustrates a passive acoustic wave torque sensor system having an acoustic wave torque sensing device which can be implemented in accordance with a preferred embodiment, the sensor system 100 consists of an acoustic wave torque sensing device 101 having a piezoelectric substrate 102, transducers 103,104, coupled to the substrate, and an antenna 106,107 integrated in the device 101.

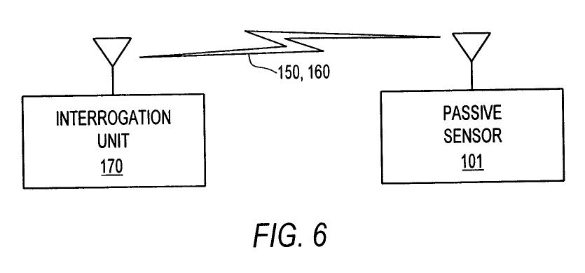

Referring to FIG. 6, which illustrates the principle of operating the passive acoustic wave torque sensor system of FIG. 5 using an interrogation unit, the passive acoustic torque sensor system 100 is adapted and arranged to receive an interrogation signal 160 from an interrogation unit 170 and to transmit an output response 150 to the interrogation unit 170 to enable remote sensing of electrical properties of a rotatable shaft at or adjacent to the interactive region 109 of the sensing device 101. The interrogation signal 160 can be a high frequency electromagnetic wave, such as an RF signal.

Note that in general, It is preferred that the orientation of the SAW (filter, resonator or delay line) torque sensing element, or the IDTs of the SAW device (filter, resonator or delay line) are arranged at an angle to the axis of the shaft. Ideally, the angle should be 45 degrees. Additionally, it is important to note that the embodiments disclosed herein can be implemented in a wide variety of applications, including automotive, transportation, rail and other similar segments for use in transmission and chassis applications, among others.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

The embodiments of the invention in which an exclusive property or right is claimed are defined as follows.

Having thus described the invention what is claimed is:

1. A torque sensor, comprising:
a variably-shaped retainer; and
an acoustic wave device removably attached to a rotatable shaft by said variably-shaped retainer, wherein removable attachment of said acoustic wave device with said variably-shaped retainer facilitates servicing and replacement of said acoustic wave device.

2. The device of claim 1 wherein said retainer comprises a geometric shape of a ring.

3. The device of claim 1 wherein said retainer comprises a geometric shape of a square.

4. The device of claim 1 wherein said retainer comprises a geometric shape of an ellipse.

5. The device of claim 1 wherein said acoustic wave device comprises at least one surface acoustic wave resonator.

6. The device of claim 1 wherein said acoustic wave device comprises at least one surface acoustic wave delay line component.

7. The device of claim 1 wherein said acoustic wave device comprises at least one surface transverse wave component.

8. The device of claim 1 wherein said acoustic wave device comprises at least one surface acoustic wave filter.

9. The device of claim 1 wherein said retainer is removably attached to said rotatable shaft by at least one connector.

10. The device of claim 1 wherein said retainer is removably attached to said rotatable shaft by an adhesive substance.

11. A torque measurement system, comprising:
a variably-shaped retainer;
at least one wireless acoustic wave torque sensor removably attached to said rotatable shaft by a variably-shaped retainer, wherein removable attachment of said wireless acoustic wave torque sensor with said variably-shaped retainer facilitates servicing and replacement of said torque measurement system.

12. The system in claim 11 wherein said at least one wireless acoustic wave torque sensor comprises at least one surface acoustic wave resonator.

13. The system in claim 11 wherein said at least one wireless acoustic wave torque sensor comprises at least one surface acoustic wave delay line component.

14. The system in claim 11 wherein said at least one wireless acoustic wave torque sensor comprises at least one surface transverse wave component.

15. The system in claim 11 wherein said at least one wireless acoustic wave torque sensor comprises at least one surface acoustic wave filter.

16. A torque sensor method, comprising
removably attaching an acoustic wave device to a rotatable shaft by a variably-shaped retainer;
monitoring said acoustic wave device in order to detect at least one attribute of torque measurement; and
removing said acoustic wave device in order to facilitate servicing and replacement of said acoustic wave device.

17. The method of claim 16 wherein said acoustic wave device comprises at least one surface acoustic wave resonator.

18. The method of claim 16 wherein said acoustic wave device comprises at least one surface acoustic wave delay line component.

19. The method of claim 16 wherein said acoustic wave device comprises at least one surface transverse wave component.

20. The method of claim 16 wherein said acoustic wave device comprises at least one surface acoustic wave filter.
